(19) United States
(12) Patent Application Publication
(10) Pub. No.: US 2011/0051404 A1
(43) Pub. Date: Mar. 3, 2011

(54) APPARATUS WITH ELECTRIC ELEMENT POWERED BY A CAPACITIVE, CERAMIC- BASED ELECTRICAL ENERGY STORAGE UNIT (EESU) WITH CHARGING INTERFACE

(76) Inventor: JOHN BOYD MILLER, (US)

(21) Appl. No.: 12/873,317

(22) Filed: Sep. 1, 2010

Related U.S. Application Data
(60) Provisional application No. 61/275,636, filed on Sep. 1, 2009.

(51) Int. Cl. F21L 4/00; H02J 7/00; H02P 1/00

(52) U.S. Cl. 362/157; 320/166; 318/139

(57) ABSTRACT

Within an apparatus (20), an electrical-energy-using element (electric element) (30) is capable of receiving power from a capacitive, ceramic-based electrical energy storage unit (EESU) (100). An EESU (100) power source within the apparatus is capable of being recharged via an on-board EESU charging interface (110).

This Non-Provisional Application Claims the Benefit of the Priority Date of Provisional Application No. 61/275,636 Filed Sep. 1, 2009.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to energy storage, energy storage charging, and energy usage within an apparatus, specifically, an apparatus contains an electrical-energy-using element (electric element), a capacitive, ceramic-based electrical energy storage unit (EESU) that is capable of operating as a power source or as a primary power source for the electric element, and an interface for charging the EESU within the apparatus.

2. Background of the Invention

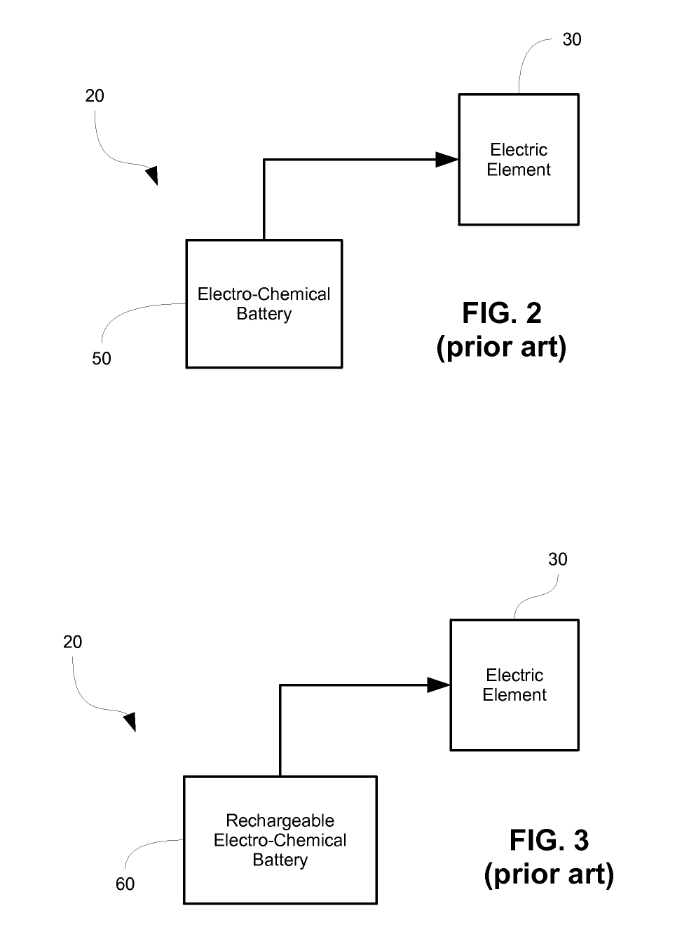

There are many devices that currently utilize electro-chemical battery electric power as their primary energy source, FIGS. 2 and 3. A key feature of these devices is the convenience of not needing to be tethered to an electrical source such as a wall socket via a cord. This makes them highly portable and convenient to users.

Many electrical and electronic devices utilize batteries in order to allow them to become portable. Examples are children's toys, personal electronics like cameras, radios and TVs, mp3 players and boom boxes, cell phones and GPS devices, computing equipment like notebook computers, portable medical electronics, portable electronic test equipment such as portable oscilloscopes, logic analyzers or protocol analyzers, vehicles such as golf carts and battery based electric automobiles, yard maintenance equipment such as mowers, weed trimmers, and leaf blowers, as well as emergency devices such as business and school emergency inside lights, crosswalk signs, and even neighborhood tornado and hurricane warning alert systems. Batteries are also utilized in power backup devices and systems such as PC backup power, an entire computer center's backup power system, or an entire factory's battery based backup power system.

For devices that use non-rechargeable batteries, FIG. 2, an advantage is that battery change-out is quick. Disadvantages to using this type of battery include the cost of continually changing out batteries, not having new batteries when a user needs them, having to store extra batteries because a user never knows when they will need fresh batteries, and throwing away used batteries creating waste and pollution issues for the environment.

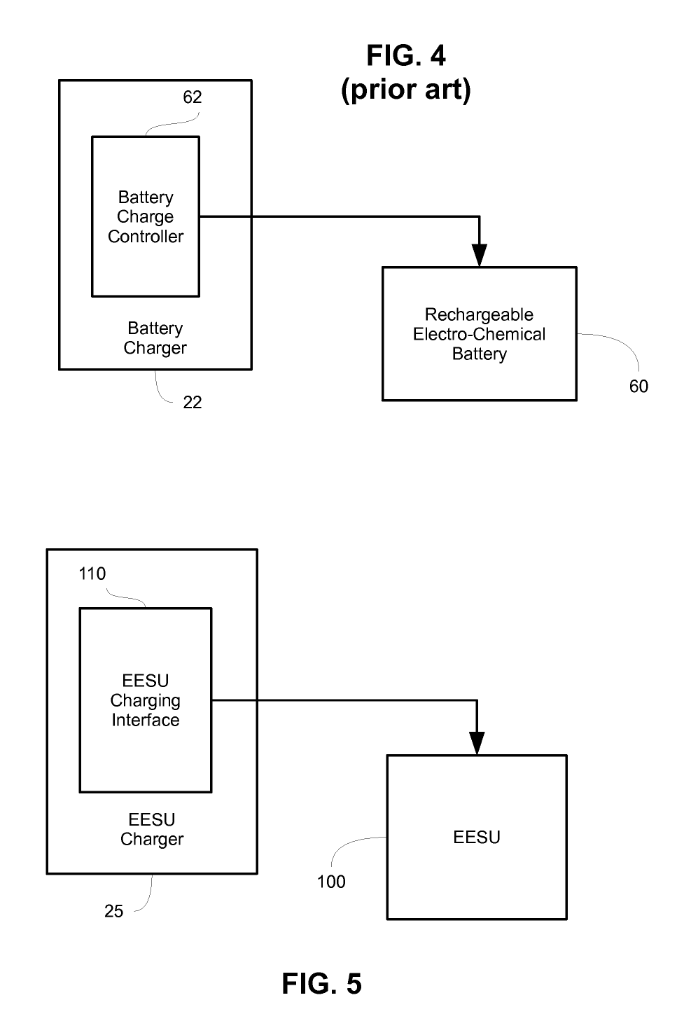

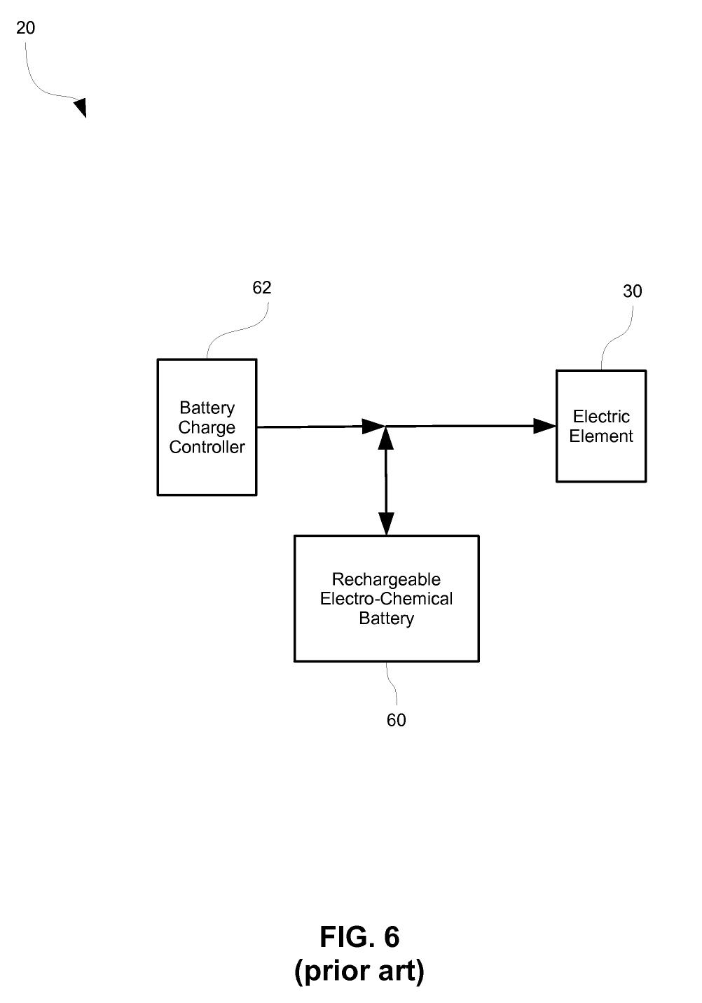

For devices that use rechargeable batteries, FIG. 3, while there is the convenience, usefulness, and sometimes a cost advantage associated with the recharge capability, a disadvantage to using this type of battery in the device is that when the battery becomes discharged with use, the battery must either be recharged for long periods of time, sometimes for hours, before being available for use again, or it must be replaced by a charged battery so the run down battery can be recharged in a charging unit. Re-use within minutes is generally not a feature of these batteries. Recharge can be accomplished with a prior art stand-alone recharge unit, FIG. 4, or with a charging unit being built into the apparatus, FIG. 6.

These rechargeable batteries in such devices, while potentially lasting for many recharge cycles, eventually get to a point where they can no longer hold a charge, they become marginally useful, and ultimately they must be disposed of. Changing out these batteries causes the user to incur costs in money as well as in time. Also, as these rechargeable batteries are disposed of, they require time, effort and cost to recycle them, or, as with non-rechargeable batteries, if they are not recycled they create waste and possibly pollution.

Another concern to users is the availability issue when it comes time for a user to replace a rechargeable battery at the end of its useful life. For example, in notebook computers, when a battery must be replaced, a user must go to the computer manufacturer or search for an equivalent replacement. Each of these methods is time consuming for the user, is usually somewhat costly for users, users generally wait days to get the new battery, and the convenience of using the computer for portable use instead of needing to be plugged into a wall socket is limited if not completely lacking for the user when a working battery in not available.

Both rechargeable and non-rechargeable batteries have shelf life issues. Shelf life is the amount of time an electro-chemical battery can sit on a shelf before its chemistry degrades to the point that it will no longer hold a charge. The longest shelf life for popular batteries is about ten years, after which they must be replaced. Most Lithium-Ion (LiIon) batteries have a shelf life of ten years, while popular alkaline AA or AAA batteries have a shelf life of only three or four years. Temperature, chemical memory issues, and the number of deep-charge cycles a battery goes through also limit the useful life of most batteries.

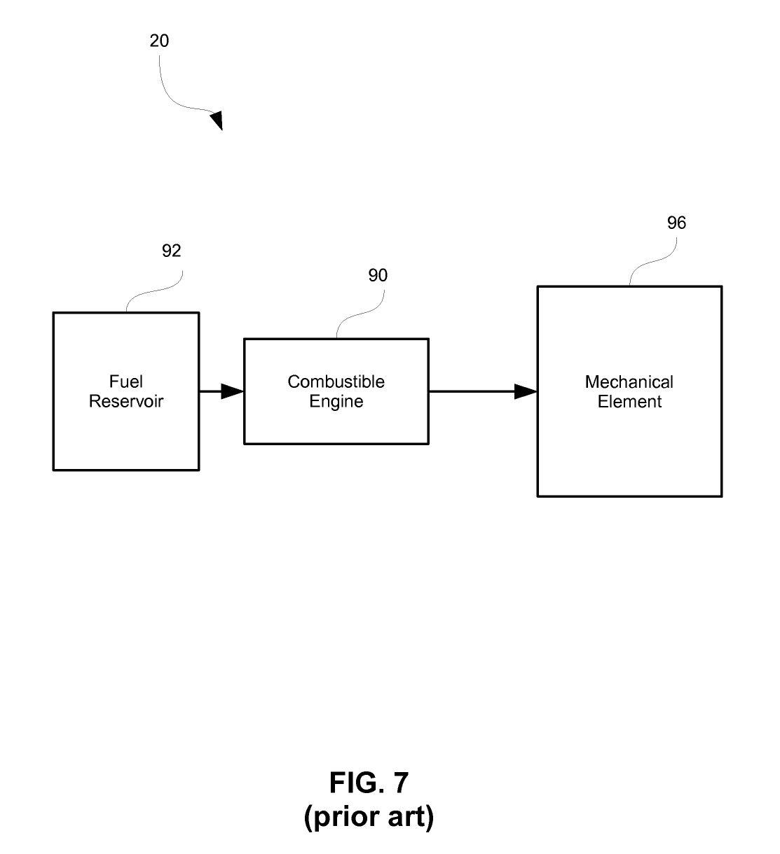

In the place of using an electro-chemical battery for power, many portable devices utilize gasoline, diesel, propane, or natural gas powered internal combustion engines to provide portable utility, FIG. 7. Examples of such devices are gas powered yard maintenance tools such as mowers, trimmers and blowers. Other examples are portable road signs and lights with gas or diesel powered engines that generate electrical energy to power the lights. Still others include portable electrical generators or backup generators that utilize an internal combustion engine to provide emergency power to homes, hospitals, businesses or other locations when another source of electric power is not available. And of course the most popular examples of portable devices that utilize internal combustion engine power are vehicles, watercraft, and aircraft.

For devices that utilize internal combustion engines, the advantages are quite apparent in that with a little combustible fuel, the devices can provide a useful amount of work. The disadvantages to utilizing this type of power for an apparatus include the requirements of handling, storage, and delivery of dangerous toxic and explosive fuels. Another disadvantage of this type of power generation is that these engines require regular maintenance to perform properly. Maintenance of these engines also requires the use, storage, and handling of somewhat messy lubrication oils. Another disadvantage is that the overall conversion efficiency of energy for useful work using an internal combustion engine is low. Even when an apparatus is idling and performing no useful work, energy is being expended. Engine exhaust is also a contributor to pollution.

A lesser used source of portable power in an apparatus is capacitors. While devices that utilize capacitors, supercapacitors, or ultracapacitors cannot store nearly the same amount of energy as many popular batteries, a device based on an ultracapacitor is capable of storing energy and is generally quite reliable for 10 years or so without changing out the capacitor power source, except in extreme temperatures, voltages, or even extreme storage conditions, which cause their charge holding and charge delivering capacities to degrade quickly.

As can readily be seen in the marketplace, capacitors are not popular as the sole power source in devices. The main reason for this is most likely their low energy storage capacities. While a popular Lithium Ion (LiIon) battery can store 150 to 200 Watt-hours per kilogram of weight (Wh/kg), the current best capacitors, ultracapacitors, are capable of storing about 60 Wh/kg of energy, with readily available commercial units being capable of storing about 3 Wh/kg of energy. This means that an apparatus would require 3 to 60 times the weight and size (and cost) for power storage with ultracapacitors as compared to utilizing a LiIon battery for power storage within a device. The size and weight added to a device using ultracapacitors, especially lower density readily available ultracapacitors, could move many of the above mentioned devices from being classified as portable devices to being classified as non-portable devices, clearly changing a major characteristic of the device and causing such devices to be less convenient and therefore less useful to users.

### BACKGROUND OF THE INVENTION

### Objects and Advantages

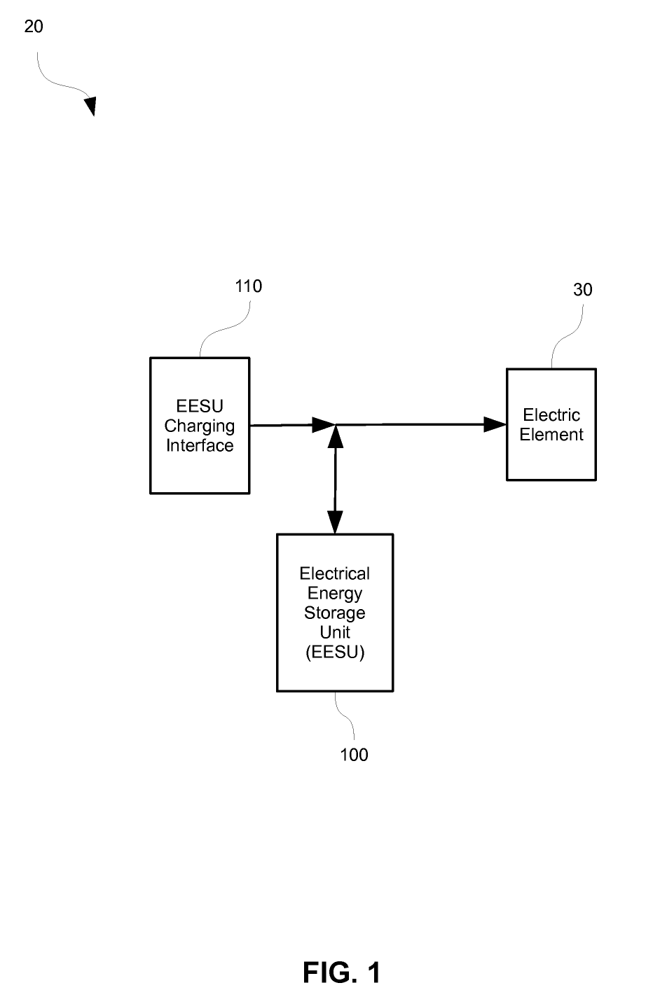

Accordingly, a solution to these issues is an apparatus, FIG. 1, that includes an electrical-energy-using element (electric element) such as a light, a display, an electrical or electronic component or circuit, a motor, an electro-mechanical component, or a combination of electric elements, that is powered by a capacitive, ceramic-based electrical energy storage unit (EESU) that is capable of storing large amounts of energy in a dense area, that is capable of recharging quickly, that does not show significant degradation over time, temperature, voltage, or with charge cycles, that does not show significant shelf-life issues, that has minimal impact on the environment, and that includes a built-in charging circuit designed specifically for the high capacitive load and voltage characteristics of the EESU.

An example of such a high density, capacitive, ceramic-based electrical energy storage unit is the Electrical Energy Storage Unit (EESU) of Richard Dean Weir, U.S. Pat. No. 7,466,536 B1. The preferred embodiment of this referenced patent shows that integrated circuit techniques are utilized to sinter extremely high permittivity Barium Titanate crystals into a bulk ceramic substrate giving a very high-density capacitive energy storage capability. The referenced patent discusses a complete ceramic based EESU with 31,351 capacitive elements connected in parallel giving a total storage capacity of 52 kilowatt-hours (kWh) at a weight of 286 pounds. As the referenced patent states, this is enough electrical energy to power a vehicle for 300 miles. Other qualities are that the EESU of the above referenced patent can be charged in about five minutes, self-discharges slower than batteries and therefore has a long shelf-life, and it is non-explosive, non-toxic, and non-hazardous. According to TABLE 1 of the referenced patent, this EESU gives over twice the energy density of LiIon batteries and over five times the energy density of NiMH or any other high-density chemistry-based batteries.

The above referenced patent covers an apparatus that is in and of itself a high density, capacitive, ceramic-based electrical energy storage unit (EESU). Versions of this EESU storage system, or other similar ceramic-based electrical energy storage units, can be made into various sizes, energy capacities and operating voltages to power small devices, large devices, and devices of any other size. By combining an EESU of appropriate size, energy capacity, and voltage to deliver energy to an electric element such as a light, a display, an electrical or electronic system, a motor, or an electro-mechanical system, and by adding recharge circuitry specifically designed to charge the EESU, an apparatus of this invention is created. Many useful portable and non-portable devices of this invention can be created, including the exemplary battery-based devices as mentioned above, as well as electrical equivalents of the internal combustion engine based devices also mentioned above, and other devices such as utility off-peak power storage devices for the electric grid to even out power generation needs, and power backup devices for home and commercial refrigeration units so food does not spoil during a power outage, where reliability, cost, size, noise, or exhaust were prohibitive factors in the popular usage of such devices previously.

For an apparatus of this invention, an example of a charging circuit designed to handle the specific charging needs of a highly capacitive load such as an EESU is a circuit based around the LTC3751 high voltage capacitor charger controller integrated circuit from Linear Technology Inc. Unlike the many battery charge controllers available today that are capable of working with various battery chemistries, this type of circuit is specifically designed to charge an energy storage device such as an EESU that contains a highly capacitive load and that works at high voltages. Specific circuitry within any EESU charging interface is determined by the charge capacity, voltage, and other parameters of the EESU, as well as by the manufacturer's preferred charge time requirements and cost goals for a particular apparatus. This allows high powered chargers to charge a device quickly in minutes, or lower powered chargers to charge a device slowly and possibly overnight.

Advantages of devices of the current invention over prior art electro-chemical battery based devices include that an apparatus of the current invention will give the user a power source with a nearly unlimited lifetime of usefulness. This is due to the EESU power source and recharge electronics within the device allowing a nearly unlimited number of recharge cycles with little degradation due to the number of recharge cycles, deep charging cycles, extreme temperatures, or extreme voltages. On the other hand, batteries in battery-based devices degrade with usage and can be recharged only a limited number of times before their energy storing capabilities degrade to the point that the batteries need to be replaced. As an example, LiIon batteries as are in cell phones can be cycled only up to about 1200 times before needing replacement. Almost all other popular battery chemistries can be cycled fewer times than this before replacement is required.

A device of this invention also has an advantage over a battery based device in that the EESU power source of this invention requires only that charge be transferred with appropriate charging circuitry from a power source, such as an electrical outlet, to the EESU, and does not require the slow process of a chemistry change and the required measured timing and charge allocation for such a process as with electro-chemical batteries. Recharging the current invention can therefore be accomplished in minutes with appropriate charging circuitry by simply plugging the device into the current electric grid. For devices of this invention that utilize more power, such as automobiles, mowers and lawn care equipment, the EESU within these devices can be charged quickly with high performance charging electronics, they can be charged slowly over time, such as overnight, with other appropriate charging electronics, or they can even be changed out quickly for a charged device and charged separately as with prior art battery powered tools.

Size and weight are another advantage for an apparatus of the current invention since the energy density of the EESU power source within the device is more dense than batteries and can therefore yield a lighter apparatus for a given power storage capability. Therefore both the size and the weight of an apparatus of the current invention can be less than with devices based on prior art chemical batteries for most energy storage capacities.

An obvious advantage of the current invention is that since an EESU power source has a nearly unlimited useful life, costs and inconvenience associated with power source replacement will be nearly eliminated, not to mention minimizing the waste, and possibly the toxic waste, associated with the disposal of millions of chemical-based batteries yearly as with prior art devices. There will also be no need to utilize energy to recycle millions of recyclable batteries when using devices of this invention. This is a clear differentiator between any battery based device and a device of the current invention.

Another advantage of this invention is that it will power relatively clean and efficient electric motors that can replace polluting internal combustion engines in many devices. These clean electric motors are generally more efficient than internal combustion engines, even when electricity generation at a power plant is taken into consideration, they will not require the handling of fuels, nor will they require regular oil changes and the associated efforts required for recycling oil as with internal combustion engines. Also, since there is generally much less maintenance on an electric motor than with an internal combustion engine, reliability issues can be minimized and cost savings can be realized for the user. Even energy availability will be less of an issue with a device of this invention since energy recharge is accomplished by connecting anywhere to the currently available electric grid. For yard equipment, such as a weed trimmer, a user will no longer be required to take the time, effort and cost to drive to a gas station and then to store messy and potentially dangerous fuels at their home or work location. Utilizing this invention in devices instead of gas or diesel engines will also eliminate the exhaust of millions of combustible engines thereby reducing pollution and heat, which could be factors in global warming.

As can be readily seen throughout the commercial, industrial, and military world, while current supercapacitors or ultracapacitors have their places, they are generally not utilized in the above mentioned devices as sole power sources. This is because of their limited energy density and the much larger overall size of an apparatus that would be realized utilizing these energy storage devices for power storage, possibly moving a device from being classified as a portable device to being classified as a non-portable device, completely changing the nature and usefulness of a device for the user.

While the best ultracapacitors demonstrate energy density of 3 to 60 Wh/kg, with typical commercially available unit power capacities being closer to 3 Wh/kg, the EESU of the above referenced patent is capable of energy density of about 400 Wh/kg giving it from 6 to over 100 times the energy density. Therefore the size and weight of an ultracapacitor storage unit for the devices mentioned above would have to be over 6 to 100 times the size and weight of an EESU storage unit that is capable of storing an equivalent amount of energy. Contrast this to using an EESU in one of the above mentioned devices, with an energy density that is over twice that of current LiIon batteries, which will allow devices of this invention to become even smaller and more convenient for users than even devices based on LiIon batteries currently allow.

As an example, for a 2000 pound vehicle to travel 300 miles, approximately 52 kilowatt-hours (kWh) of energy will be required (as shown in the above referenced patent). A vehicle can travel this distance utilizing a 286 pound EESU power source that is capable of storing 52 kWh of energy. Equivalently, to travel this distance it would take a vehicle capable of handling the size and weight of ultracapacitors weighing from 1,800 pounds to 36,000 pounds just for the ultracapacitor power storage, with generally available ultracapacitors weighing closer to 36,000 pounds. This would change vehicles as we know them today and could very well change their usefulness. The same argument can be used for nearly all the above mentioned devices. It can easily be seen that by putting power storage into these devices that is 3 to 60 times the size and weight of power storage in current devices, many of the above mentioned devices would become non-portable, severely limiting their usefulness for their intended portable purposes. In other words, utilizing such large and heavy energy storage in such a device could change the nature of the apparatus itself to a device that is possibly completely non-portable.

Also, while an ultracapacitor can experience a loss of power storing and usage capabilities during extreme conditions such as charging and discharging at high temperatures, excessive charging voltages, or even when a power unit sits unused for long periods of time such as might occur in military and emergency uses, an EESU of the above referenced patent does not degrade with temperatures or overvoltages (less than 5×10̂6 Volts).

As can be seen above, devices of the current invention have operational features and capabilities that are markedly different from prior art devices powered by batteries, by internal combustion engines, or by capacitors and ultracapacitors.

Table 1 below shows that while most batteries of various chemistry make-ups show mostly similar traits, an apparatus of this invention shows capabilities of being able to operate in different environments, with different limitations, and with different features, than a battery based apparatus that performs a similar function.

Similarly, Table 2 show that a device of this invention offers significant operational differences and features from a device powered by an internal combustion engine that performs a similar function.

And in Table 3, a device of this invention can clearly be seen as useful as a portable device since the energy density of the devices' EESU power source is twice that of popular LiIon batteries, therefore giving the potential for an even smaller power source and an even smaller overall apparatus size than is generally available today, giving the user even more convenience. On the other hand, a similar device utilizing prior art ultracapacitors as a power source would be of such a size and weight that its use as a portable device would be limited and could possibly be seen as changing the device from a portable device to a non-portable device, changing the nature and usefulness of the device for the user completely. Very possibly only trains and some extreme military or national defense devices could be considered viable portable devices with such a large and heavy power source.

TABLE 1
Operational And Functional Feature Differences: Prior Art
Battery Powered Apparatus vs. Current Invention Apparatus

| A Prior Art Apparatus With Electro- | An Apparatus Of This Invention |
|---|---|
| Chemical Battery Power Source | With An EESU Power Source |
| Expect Unreliable Apparatus Performance | Expect The Same Reliable Apparatus |
| After A Period Of Time | Performance Indefinitely |
| Due to Battery Chemistry Degradation | No Chemistry To Degrade In EESU |
| Due to Battery “Memory Effect” | No “Memory Effect” In EESU |
| Due to Battery “Deep Cycling” | No Issues Due To “Deep Cycling” In |
| | EESU |
| Expect To Change Out Apparatus Battery After | No Need To Change Out Apparatus EESU |
| A Period Of Time Due To “Normal Wear” | Because Of “Normal Wear” |
| Time And Effort Inconvenience For User | No Inconvenience To User |
| Cost For User | No Cost To User |
| Device Itself Becomes Unusable If | Apparatus Generally Only Becomes |
| Replacement Battery Not Found Or Is | Unusable With Mechanical Element |
| Not Cost Effective | Wear Or Breakage |
| If Apparatus Uses “Throw Away” Batteries, | Apparatus Uses Rechargeable EESU, It Is Not |
| Expect To Pollute The Environment After | A “Throw Away”, It Is Rechargeable |
| Battery Is Discharged And Discarded | Indefinitely. EESU Is Ceramic Based, |
| | No Toxic Pollution When Discarded |
| If Apparatus Utilizes Recyclable Battery, | Apparatus Will Generally Not Degrade To The |
| Expect To Require Time, Effort, And Cost To | Point Of Requiring EESU Replacement. |
| Recycle Battery After A Period Of Time | EESU Could Possibly Be Used Or Sold As |
| | Useful Power Storage Device |
| | Even After The Rest Of The Apparatus |
| | Is Discarded Or Replaced |
| After Apparatus Battery Is Discharged, | After Apparatus EESU Is Discharged, |
| Apparatus Is Unusable Until Battery Is | Apparatus Is Unusable Until EESU Is |
| Charged Or Changed Out | Charged Or Changed Out |
| Battery Requires Electro-Chemical | EESU Needs Only To Transfer Charge, |
| Transfer, Charges Slowly At A Measured | Charging Can Take Place In Minutes |
| Pace Over Hours To Charge Fully | Fast Charge To Full Charge In EESU |
| Fast Charge To Full Charge Is Generally | Is Standard Practice |
| Not Possible With Batteries | Replacement EESU Is Not Required If |
| Replacement Battery Is Generally Used | User Can Wait Minutes For Recharge |
| While Primary Battery Is Charging | (Or Possibly Less Than A Minute In |
| Second, Third, Or Even Fourth | Small EESUs) |
| Replacement Battery Sometimes | Second EESU Can Be Used When No Wait |
| Required During Primary Battery Charge | Time Is Preferred By User |
| Period | |
| Extreme Temperatures Limit Usefulness And | Extreme Temperatures Do Not Limit |
| Reliability Of Apparatus With Battery Due To | Usefulness Of Apparatus Due To EESU, |
| Battery Chemistry Issues | Although Other Electronics And Mechanicals |
| | Possibly Affect Reliability |

TABLE 2
Operational And Functional Feature Differences: Prior Art Internal
Combustion Engine Powered Apparatus vs. Current Invention Apparatus

| Prior Art Apparatus | Apparatus Of This Invention |
|---|---|
| With Fuel Engine Power Source | With EESU Power Source |
| Apparatus Takes Only Minutes To Refuel | Apparatus Takes Only Minutes To Recharge |
| Apparatus Is Usually Noisy Due To | Apparatus Is Usually Quiet Due To |
| Engine Noise | Electric Motor Being Relatively Quiet |
| Muffler Always Required | No Muffler Required |
| Apparatus Requires User Deal With Fuels | Apparatus Requires User To Power Device |
| That Are Explosive, Toxic, And “Messy” | Somewhat Like Many Current Home |
| | Appliances And Tools |
| To Fuel Apparatus, Travel To A “Gas Station” | Charging Apparatus Can Be Done Anywhere |
| Required | From The Current Electric Grid, |
| | Even From Home Or Work |
| Fuels To Refuel Apparatus Must Be | Energy To “Recharge” Apparatus Is Available |
| Transported Via Trucks To “Gas Stations” | Everywhere The Electric Grid Is Available |
| Requires Transport Time, | Electricity Delivery Costs And |
| Transport Cost, And | Maintenance Is Shared With Current |
| Pollution From Delivery Trucks | Electric Grid Users |
| Extra Fuel Can Travel With Apparatus To | Extra Replaceable EESU Power Modules Can |
| Refuel Anywhere | Travel With Apparatus To Replace |
| | Discharged Modules Anywhere |
| Apparatus Emits Exhaust Emissions | Apparatus Emits No Exhaust Emissions, |
| | Not Even Vent Gasses |
| Engines In Apparatus Require Periodic | Apparatus Motor Requires Little Maintenance, |
| “Tune Up” And Maintenance | Similar To High Use Air Conditioning |
| | Condenser Or Fan Motors |
| Apparatus Complicated By | Apparatus Similar To |
| Complex Mechanical Engine | Simple Electric “Appliance” |
| Apparatus Utilizes Fuel Energy Inefficiently | Apparatus Energy Utilization Is More Efficient |
| Internal Combustion Engine Overall | Than For Internal Combustion Engine Apparatus |
| Efficiency At Converting Energy To | Even After Electricity Generation, A |
| Useful Work Is Low | Vehicle With An Electric Motor Is Nearly |
| Fuel Engines Utilize Energy Even At Idle | Twice As Efficient As A Vehicle With An |
| Times When No Useful Work Is Done | Internal Combustion Engine |
| | Energy Usage Can Be Stopped During |
| | Idle Periods To Conserve Energy |

TABLE 3
Operational And Functional Feature Differences: Prior Art UltraCapacitor
Powered Apparatus vs. Current Invention Apparatus

| Prior Art Apparatus With | Apparatus Of This Invention |
|---|---|
| UltraCapacitor Power Source | With EESU Power Source |
| Apparatus capable of 10 year | Apparatus capable of greater than |
| life with little power source | 10 year life regardless of |
| degradation unless used in extreme | extreme temperatures or voltages. |
| temperatures, voltages or storage | |
| situations. | |
| Size and Weight, due to limited | Size and Weight, due to high energy |
| energy density, restricts | density, allows smallest and lightest |
| apparatus from being portable in | apparatus compared to any popular |
| all but extreme applications. | electro-chemical battery based |
| | apparatus, inviting use in all |
| | portable devices and applications. |

Through the comparisons shown in Tables 1, 2 and 3, it can be seen that an apparatus of this invention has distinctively different operational capabilities and features than either a prior art battery based apparatus, an apparatus with an internal combustion engine, or a prior are capacitor or ultracapacitor based apparatus. Even hybrid vehicles with gasoline engines, batteries, and capacitors are not only different, but include many of the differences of each prior art apparatus, a battery based apparatus, an engine based apparatus, and a capacitor based apparatus, each with their own clear differences.

There are also differences in the built-in charging circuits of an apparatus of the current invention verses a prior art apparatus with a battery. While an EESU charging circuit must be capable of charging into a huge capacitor with significant current control and current limiting capabilities built into the circuit, a prior art battery charger must utilize charging algorithms to provide varying voltages and currents at different stages of the charging process to suit the particular chemistry make-up of the battery. Even prior art capacitor and ultracapacitor charging circuits must use caution to avoid allowing overvoltage lest the charge carrying capabilities and the charge releasing capabilities of the capacitor be degraded. The EESU, as described in the above referenced patent, does not exhibit these limitations.

As can readily be seen, an apparatus of the current invention containing an EESU such as that referenced in the above patent, or a similar ceramic based energy storage device with similar qualities, has a significant advantage over an apparatus designed for a similar use that utilizes a prior art electro-chemical battery. Therefore it can be easily seen by one skilled in the art that an apparatus of this invention is clearly not just another battery based device with a new type of battery that includes many of the prior art electro-chemical battery's features and limitations.

Likewise, since an apparatus of the current invention containing an EESU has the advantage of allowing nearly any of the above mentioned devices to be portable and to have even smaller sizes and weights than current prior art devices, an apparatus of this invention clearly has different features and operational capabilities than prior art devices utilizing capacitors or ultracapacitors as their sole power source.

Other objects and advantages of this invention will become apparent from a consideration of the ensuing description and drawings.

Thank you, Lord, for this great inspiration. Thank you Spirit of God for your guidance.

### SUMMARY

In accordance with the present invention, an apparatus includes an electrical-energy-using element (electric element) such as a light, an electrical or electronic component, a motor, or an electromechanical device, and a capacitive, ceramic-based electrical energy storage unit (EESU) that is capable of operating as a power source, or possibly a primary power source, for the electric element within the apparatus, the EESU within the apparatus being capable of being recharged via a built-in charging interface.

### DRAWINGS

### Figures

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in an embodiment” or “in an alternate embodiment” appearing herein describe various embodiments and implementations of the invention, and do not necessarily all refer to the same embodiment, however, they are also not necessarily mutually exclusive.

FIG. 1 shows an apparatus with an electric element, an EESU as a power source, and an EESU charging interface, according to an embodiment of the invention.

FIG. 2 shows a prior art apparatus with a non-rechargeable battery.

FIG. 3 shows a prior art apparatus with a rechargeable battery.

FIG. 4 shows a prior art rechargeable battery and a stand-alone battery charger for it.

FIG. 5 shows an EESU and a stand-alone EESU charger.

FIG. 6 shows a prior art apparatus with an electric element, a rechargeable battery, and a battery charge controller circuit.

FIG. 7 shows a prior art apparatus with a mechanical element, an internal combustion engine driving the mechanical element, and a fuel reservoir for the internal combustion engine.

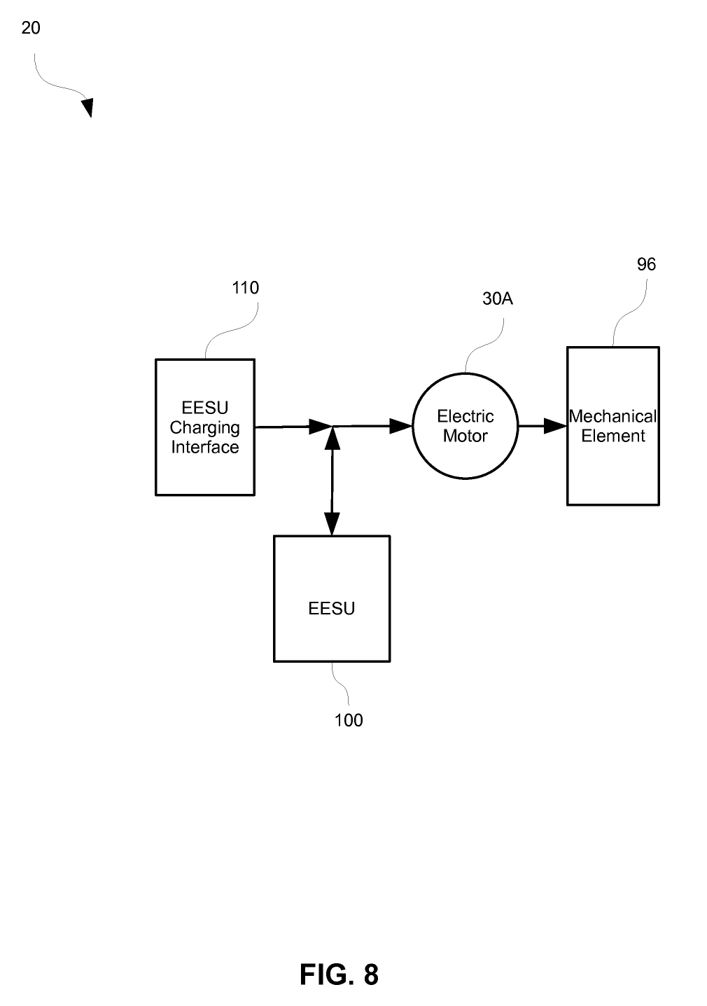

FIG. 8 shows an apparatus with a mechanical element, an electric motor driving the mechanical element, an EESU power source, and an EESU charging interface, according to an embodiment of the current invention.

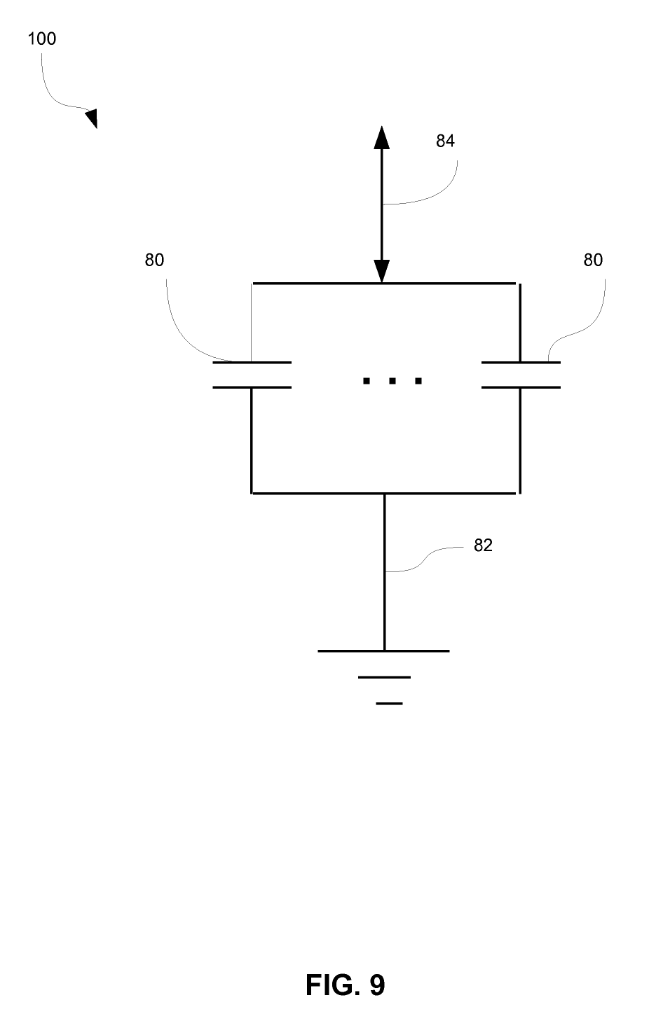

FIG. 9 shows an EESU with multiple capacitive elements, an Input/Output port, and a common port.

### REFERENCE NUMERALS

20 An Apparatus
22 Stand-Alone Prior Art Battery Charger
25 Stand-Alone EESU Charger
30 Electric Element
30A Electric Motor as Electric Element
50 Non-Rechargeable Chemical Battery
60 Rechargeable chemical Battery
62 Battery Charge Controller (Prior Art)
80 Capacitive Element
82 EESU Common
84 EESU Input/Output
90 Combustible Engine
92 Fuel Reservoir for Combustible Engine
96 Mechanical Element
100 Electrical Energy Storage Unit (EESU)
110 EESU Charging Interface

### DETAILED DESCRIPTION AND OPERATION

### FIG. 1—Preferred Embodiment

A preferred embodiment for an apparatus of the present invention is illustrated in FIG. 1. An apparatus 20 includes an electrical energy storage unit (EESU) 100 to store electrical energy, an EESU charging interface 110 to allow charging of the EESU 100, and an electric element 30 such as a light, an electronic or electrical system, a motor for driving a mechanical system, or some other electro-mechanical system capable of providing a useful output for the user. Power to the EESU charging interface 110 comes from standard 110 volt or 220 volt alternating current (AC) or other source (not shown).

The EESU 100 is made up of multiple capacitive elements 80 connected in parallel, as shown in FIG. 9. As with most common capacitors, input/output 84 is connected on one side of the parallel capacitive elements and a common reference 82 is connected to the other side.

The on-board EESU charging interface 110 within the apparatus of this embodiment of the invention can have the same electrical characteristics as that of the EESU charging interface 110 in the stand-alone EESU charger 25 of FIG. 5. An example of an EESU charging interface 110 is a complex integrated circuit capable of charge transfer to a capacitive device, with optional voltage regulation, overvoltage and undervoltage detection, thermal protection, and other features, and with discrete circuitry around it. Another example is a simple electrical, mechanical, or combination electrical and mechanical interface.

Prior art apparatus that offer similar utility features to that of the current invention are shown in FIGS. 2, 3, and 6, with FIG. 4 being an illustration of a prior art stand-alone battery charger 22 with a prior art rechargeable battery 60. Similar to the preferred embodiment of FIG. 1, the prior art apparatus of FIG. 6 features a rechargeable battery 60 to provide power to an electric element 30, a built-in battery charge controller 62 to charge the battery, and an electric element 30 as a useful output for the user.

### Operation—FIGS. 1, 2, 3, 4, 5, 6

Operational features of the FIG. 1 preferred embodiment of the current invention are similar to those of a prior art apparatus as shown in FIGS. 2, 3, 4, and 6. FIG. 2 shows a prior art apparatus that uses a standard, non-rechargeable battery 50 as the an energy source to power an electric element 30 such as a light, an electronic or electrical system, a motor capable of driving a mechanical system, or some other electro-mechanical system. FIG. 3 shows an apparatus similar to the apparatus in FIG. 2 but with the enhancement of using a rechargeable battery 60.

FIG. 6 shows a prior art system similar to the embodiment of FIG. 1 with a rechargeable battery 60 as the primary energy source to power an electric element 30, and a battery charge controller 62 as an enhancement to the apparatus of FIG. 3 that controls the charge process for the rechargeable battery 60. FIG. 4 shows a prior art rechargeable battery with a stand-alone battery charger 22. The stand-alone battery charger can utilize a battery charge controller 62 that is similar to or the same as that of the FIG. 6 apparatus.

The operation for the preferred embodiment of this invention, FIG. 1, is similar to that of the prior art apparatus 20 of FIG. 6. In normal operation electrical energy flows from the primary energy source, the EESU 100, to the electric element 30, and the electric element 30 operates in the manner for which it was designed. As energy is utilized to power the electric element 30, energy within the EESU 100 is depleted. The EESU 100 is recharged via the EESU charging interface 110. The EESU charging interface 110 receives energy from an external source such as a standard 110 volt or 220 volt AC wall outlet or other power source (not shown).

An exemplary apparatus 20 of the invention would be a rechargeable flashlight with an EESU 100 as its energy source, a light bulb as the electric element 30, and a built-in EESU charging circuit 110 to charge the EESU 100.

An exemplary EESU charging circuit 110 is based on an LTC3751 high voltage capacitor charger controller integrated circuit from Linear Technology Inc. Besides periphery circuitry, as shown for specific configurations in the data sheet for the LTC3751, the LTC3751 capacitor charger controller simply requires AC rectification and voltage regulation circuitry at its input to be powered from 110 volts AC or 220 volts AC.

When the light bulb is placed in the circuit, energy flows from the charged EESU 100 to the light bulb and the light bulb illuminates. To recharge the EESU 100, power flows from a power source (not shown), such as 110 Volt or 220 Volt wall outlets as can be found in many homes and businesses throughout the world, through the EESU charging interface 110 and to the EESU 100.

### FIGS. 7, 8

### Additional Embodiment

FIG. 7 shows a prior art apparatus 20 with a mechanical element 96, an internal combustion engine 90, and a fuel reservoir 92.

Similarly, FIG. 8 shows an additional embodiment of the current invention. An apparatus 20 includes a mechanical element 96 to provide a useful output for the user, an electric motor 30A as the electric element capable of providing motion for the mechanical element, an EESU 100 to store electrical power in the apparatus, and an EESU charging interface 110 to charge the EESU 100. Power to the EESU charging interface 110 comes from a standard 110 volt AC or 220 volt AC wall outlet or other source (not shown).

### Operation—FIGS. 7, 8

The operation of the FIG. 7 prior art apparatus 20 shows a mechanical element 96 being driven by an internal combustion engine 90. The energy to fuel the internal combustion engine 90 comes from the fuel reservoir 92. To recharge this apparatus, fuel is added into the fuel reservoir 92.

The operation for the apparatus 20 of the FIG. 8 embodiment of the current invention varies from the operation of the prior art apparatus of FIG. 7 in that an electric motor 30A operates as the electric element of the invention and is utilized to drive the mechanical element 96 instead of utilizing the combustible engine 90 to drive the mechanical element 96 as in the prior art. Electrical energy from the EESU 100 drives the electric motor 30A. The EESU 100 is charged when necessary by passing energy through the EESU charging interface 110 to the EESU 100. The EESU charging interface 110 receives energy from an external source such as a standard 110 volt or 220 volt AC wall outlet or other source (not shown).

An exemplary apparatus 20 of this embodiment would be similar to a gasoline powered weed trimmer as is illustrated in FIG. 7. The common prior art weed trimmer utilizes a small gasoline engine 90 to drive a rotating mechanical trimmer 96. The energy for the gasoline engine 90 is stored in the weed trimmer in a small gasoline storage tank 92. To recharge the gasoline powered weed trimmer, a user would refill the gasoline storage tank 92.

A weed trimmer of the preferred embodiment, FIG. 8, utilizes an electric motor 30A as the electric element to drive a rotating mechanical trimmer 96. Electrical energy from an EESU 100 powers the electric motor 30A. To recharge the EESU 100 when necessary, power flows from a power source (not shown) through the EESU charging interface 110 and to the EESU 100. Again, an exemplary EESU charging circuit 110 includes a circuit based on the LT3751 high voltage capacitor charger controller integrated circuit from Linear Technology.

### CONCLUSION, RAMIFICATIONS, AND SCOPE

Thus the reader can see that many useful and convenient devices can be created for users utilizing the elements of this invention, devices with unique features and operational capabilities that are distinct from prior art devices based on electro-chemical batteries, internal combustion engines, and ultracapacitors.

Improvements over prior art devices include compactness due to the EESU having higher energy density than batteries or ultracapacitors thus making many devices even more portable, convenient, and useful than is possible in prior art devices. Also, due to the greatly enhanced and nearly unlimited recharge capability, its ability to utilize the on-board charging interface to readily recharge from nearly anywhere on the current electric grid, the ruggedness over temperature and voltage variations, and the enhanced shelf life of the EESU, recharging devices of this invention affords long lasting convenience to the user while requiring little need for the user to change out and discard an EESU as with prior art batteries. Lower pollution, mess, and overall energy usage are the key features when comparing an apparatus of this invention with an apparatus based on an internal combustion engine. Thus, smaller size, better portability, better durability, reduced waste, reduced pollution, and better user convenience are all key features of devices that utilize the elements of this invention.

While the above description contains many specificities, these should not be construed as limitations on the scope of the invention, but rather as exemplifications of preferred embodiments thereof. Many other variations are possible. For example, the EESU need not be limited to the EESU of Richard Dean Weir, U.S. Pat. No. 7,466,536 B1. Other capacitive, ceramic-based electrical energy storage units utilizing ceramic sintered with other substances of high permittivity may also be utilized. Of course various storage capacities, various unit sizes, and various operating voltages may also be utilized.

The on-board EESU charging interface can consist of any interface capable of charging the EESU, not just electronic circuitry based on the LTC3751 high voltage capacitor charger controller integrated circuit as exemplified above.

An electric element can consist of not just a light, an electronic or electrical component or circuit, a motor-driven mechanical system, or some other electro-mechanical system, but of any electric element capable of being driven by an electrical energy source in an apparatus.

Thus the scope of the invention should be determined by the appended claims and their legal equivalents, rather than by the examples given.

I claim:

1. An apparatus, comprising:
an electrical-energy-using element (electric element),
a capacitive, ceramic-based electrical energy storage unit (EESU), and
an interface capable of charging said EESU,
wherein said EESU is capable of operating as a power source for said electric element.

2. The electrical energy storage unit (EESU) of claim 1 wherein said EESU is rechargeable.

3. The electric element of claim 1 wherein said element includes a light.

4. The electric element of claim 1 wherein said element includes an electronic circuit.

5. The electric element of claim 4 wherein said electronic circuit includes computing circuitry.

6. The electric element of claim 4 wherein said electronic circuit includes display circuitry.

7. The electric element of claim 1 wherein said element includes an electrical component.

8. The electric element of claim 1 wherein said element includes an electric motor.

9. The electric element of claim 8, wherein said motor drives a mechanical element.

10. An apparatus, comprising:
an electrical-energy-using element (electric element),
a capacitive, ceramic-based electrical energy storage unit (EESU), and
an interface capable of charging said EESU,
wherein said EESU is capable of operating as the primary energy source for said electric element.

11. In an apparatus, a method of delivering electrical energy comprising:
supplying electrical energy to an electrical-energy-using element (electric element) from a capacitive, ceramic-based electrical energy storage system (EESU), and
charging said EESU through an interface capable of charging said EESU,
wherein said EESU is capable of operating as the primary energy source for said electric element.

12. The electrical energy storage unit (EESU) of claim 11 wherein said EESU is rechargeable.

13. The electric element of claim 11 wherein said element includes a light.

14. The electric element of claim 11 wherein said element includes an electrical circuit.

15. The electric element of claim 11 wherein said element includes an electric motor.

16. The electric element of claim 11 wherein said element includes an electro-mechanical component.

17. The interface capable of charging said EESU of claim 11 wherein said interface includes an on/off switch mechanism.

18. The interface capable of charging said EESU of claim 11 wherein said interface includes voltage conversion circuitry.

19. The interface capable of charging said EESU of claim 11 wherein said interface includes charge transfer circuitry.

20. The interface capable of charging said EESU of claim 11 wherein said interface includes charge control circuitry.
